(19) United States
(12) Patent Application Publication
(10) Pub. No.: US 2020/0242394 A1
(43) Pub. Date: Jul. 30, 2020

(54) DISPLAY CONTROL METHOD AND DISPLAY CONTROL APPARATUS

(71) Applicant: FUJITSU LIMITED, Kawasaki-shi (JP)

(72) Inventors: Yu Hashimoto, Ota (JP); Tomoyuki Baba, Narashino (JP); Ximing Li, Ota (JP); Takuya Kozaki, Yokohama (JP)

(73) Assignee: FUJITSU LIMITED, Kawasaki-shi (JP)

(21) Appl. No.: 16/715,264

(22) Filed: Dec. 16, 2019

(30) Foreign Application Priority Data
Jan. 25, 2019 (JP) 2019-011614

(51) Int. Cl. G06K 9/62; G06K 9/46; G06T 11/00

(52) U.S. Cl. CPC G06K 9/6202; G06T 11/00; G06K 9/4604

(57) ABSTRACT

A display control method includes: selecting, by a computer, a predetermined number of edge lines from a plurality of edge lines extracted from a captured image including an image of a structure; selecting the predetermined number of ridge lines from a plurality of ridge lines included in a three-dimensional model of the structure; determining whether a correspondence relationship between a distribution condition of the predetermined number of edge lines in an image region of the image of the structure and a distribution condition of the predetermined number of ridge lines in a projection image region of a first projection image of the three-dimensional model meets a first criterion; and generating, when the correspondence relationship meets the first criterion, a second projection image of the three-dimensional model where a positional relationship of the predetermined number of edge lines corresponds to a positional relationship of the predetermined number of ridge lines.

### CROSS-REFERENCE TO RELATED APPLICATION

This application is based upon and claims the benefit of priority of the prior Japanese Patent Application No. 2019-11614, filed on Jan. 25, 2019, the entire contents of which are incorporated herein by reference.

### FIELD

The embodiments discussed herein are related to a display control method and a display control apparatus.

### BACKGROUND

A technology has been known that displays a projection image of a three-dimensional model of a structure over a captured image of the structure. For example, according to the technology, processing is performed that identifies a display attitude of a three-dimensional model based on edge lines extracted from the captured image. This technology is used for examining whether a manufactured structure is not different from pre-generated three-dimensional (3D) computer aided design (CAD) data.

Related techniques are disclosed in, for example, Japanese Laid-open Patent Publication No. 2018-142109.

The technology has a problem that an enormous amount of computational effort may be required for the identification of the display attitude of a three-dimensional model of a structure. According to the technology, combinations of edge lines in a captured image and ridge lines in a projection image of a three-dimensional model are selected, and a display attitude of the three-dimensional model is identified such that errors between the feature lines may be as small as possible. In this case, according to the technology, because the errors and so on are computed with respect to the enormous number of combinations, the amount of computational effort may increase to the extent that the computing is not finished within a practical period of time.

### SUMMARY

According to an aspect of the embodiments, a display control method includes: selecting, by a computer, a predetermined number of edge lines from a plurality of edge lines extracted from a captured image including an image of a structure; selecting the predetermined number of ridge lines from a plurality of ridge lines included in a three-dimensional model of the structure; determining whether a correspondence relationship between a distribution condition of the predetermined number of edge lines in an image region of the image of the structure and a distribution condition of the predetermined number of ridge lines in a projection image region of a first projection image of the three-dimensional model meets a first criterion; generating, when the correspondence relationship meets the first criterion, a second projection image of the three-dimensional model where a positional relationship of the predetermined number of edge lines corresponds to a positional relationship of the predetermined number of ridge lines; and displaying the generated second projection image over the captured image on a display unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. t is a diagram illustrating an example of a functional configuration of a display control apparatus according to an embodiment;

FIG. 2 is a diagram illustrating an example of a captured image;

FIG. 3 is a diagram illustrating an example of a projection image of a three-dimensional model;

FIG. 4 is a diagram illustrating an example of a feature line to be extracted;

FIG. 5 is a diagram illustrating an example of a feature line not to be extracted;

FIG. 6 is a diagram for explaining angles formed by feature lines;

FIG. 7 is a diagram illustrating an example of feature lines when the arrangement relationship meets a criterion for arrangement;

FIG. 8 is a diagram illustrating an example of feature lines when the arrangement relationship does not meet a criterion for arrangement;

FIG. 9 is a diagram illustrating an example of feature lines when the correspondence relationship meets a criterion for correspondence;

FIG. 10 is a diagram illustrating an example of feature lines when the correspondence relationship does not meet a criterion for correspondence;

FIG. 11 is a flowchart illustrating a flow of display control processing;

FIG. 12 is a flowchart illustrating a flow of processing for extracting feature lines;

FIG. 13 is a flowchart illustrating a flow of processing for determining a distribution condition of feature lines; and

FIG. 14 is a diagram illustrating an example of a hardware configuration.

### DESCRIPTION OF EMBODIMENTS

Embodiments will be described in detail below with reference to the drawings. Note that the embodiments do not limit the present disclosure. Embodiments may be combined with each other as appropriate when there is no contradiction.

As an example, a display control method and a display control apparatus according to an embodiment is usable for checking whether a manufactured structure and a three-dimensional model of the structure are not different from each other. For example, the display control apparatus may generate a projection image of a three-dimensional model of a structure after fitting the attitude of the structure in a captured image to the attitude of the three-dimensional model of the structure and display the projection image over the captured image.

Attitude estimation processing for fitting the attitude of the three-dimensional model to the attitude of the structure in the captured image imposes a particularly large processing load. In the attitude estimation processing, an error is calculated for each of combinations of edge lines acquired from the captured image of the structure and ridge lines of the projection image of the three-dimensional model. Accordingly, in the embodiment, in order to reduce the amount of computational effort, the combinations of edge lines and ridge lines are narrowed prior to the actual computing of an error.

[Functional Configuration]

A functional configuration of a display control apparatus according to the embodiment will be described with reference to FIG. 1. FIG. 1 is a diagram illustrating an example of a functional configuration of the display control apparatus according to the embodiment. For example, a display control apparatus 10 is an information processing apparatus such as a smartphone, a tablet terminal or a personal computer. As illustrated in FIG. 1, the display control apparatus 10 includes a display unit 11, an image-capturing unit 12, a storage unit 13 and a control unit 14.

The display unit 11 displays an image under control of the control unit 14. For example, the display unit 11 is a touch panel display or the like. The image-capturing unit 12 captures an image. For example, the image-capturing unit 12 is a camera.

The storage unit 13 is an example of a storage device that stores data and a program to be executed by the control unit 14 and is, for example, a hard disk, a memory, or the like. The storage unit 13 stores therein 3D model information 131.

The 3D model information 131 is data generated by 3D CAD or the like and is data for constructing a three-dimensional model of a structure. With the 3D model information 131, a projection image of a three-dimensional model of a designated structure may be generated. The control unit 14 performs processing on a three-dimensional model with reference to the 3D model information 131 as required.

The control unit 14 is implemented by a processor such as a central processing unit (CPU), a microprocessor unit (MPU), or a graphics processing unit (GPU), when executing a program stored in an internal storage device by using a random access memory (RAM) as a workspace. The control unit 14 may also be implemented as, for example, an integrated circuit, such as an application specific integrated circuit (ASIC) or a field-programmable gate array (FPGA). The control unit 14 has an extracting unit 141, a selecting unit 142, a determining unit 143, a generating unit 144, and a display control unit 145.

The extracting unit 141 extracts an edge line from a captured image of a structure captured by the image-capturing unit 12. The extracting unit 141 may extract an edge line by using a known method. For example, the extracting unit 141 may extract an edge line based on differences of light and dark between pixels in a captured image.

The extracting unit 141 further extracts a ridge line in a three-dimensional model. More specifically, for example, the extracting unit 141 acquires a ridge line of a projection image generated from a three-dimensional model. The term “ridge line” refers to an edge line of a part visualized as a projection image of a three-dimensional model.

A user may manually manipulate an attitude of a three-dimensional model by using a CAD tool or the like. Thus, the extracting unit 141 may acquire a ridge line from a projection image of a three-dimensional model having an attitude manipulated based on a structure that has been already captured or to be captured. The projection image from which the extracting unit 141 acquires a ridge line is an example of a first projection image.

Hereinafter, an edge line extracted from a captured image by the extracting unit 141 may also be called a 2D feature line. A ridge line extracted from a projection image of a three-dimensional model by the extracting unit 141 may also be called a 3D feature line. A 3D feature line and a 2D feature line may also simply be called a feature line without distinction between them. All of the feature lines are segments each having a length.

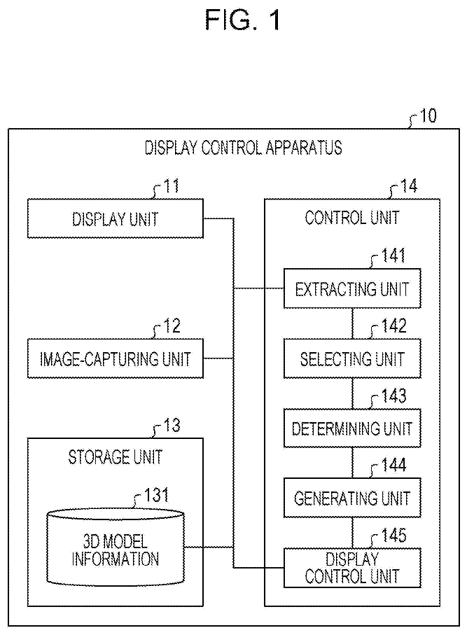

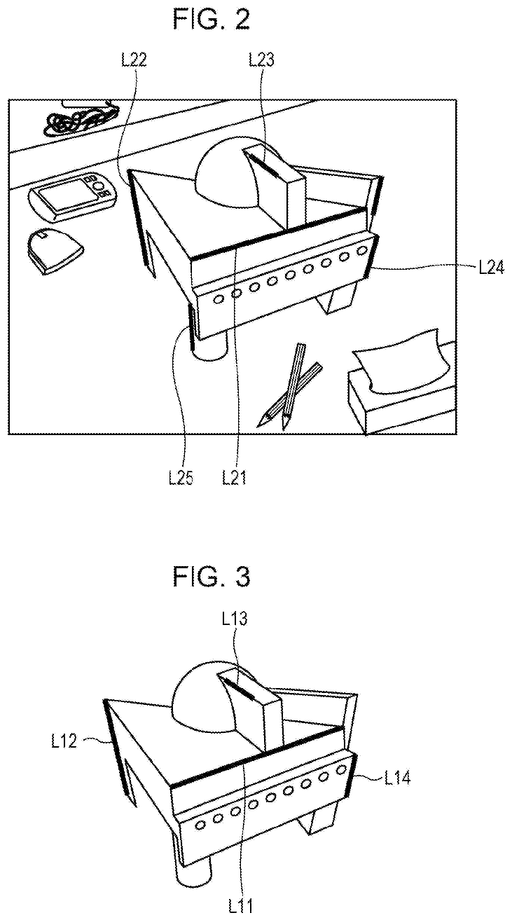

FIG. 2 is a diagram illustrating an example of a captured image. Feature lines L21, L22, L23, L24, and L25 are examples of edge lines extracted by the extracting unit 141, that is, 2D feature lines.

FIG. 3 is a diagram illustrating an example of a projection image of a three-dimensional model. Feature lines L11, L12, L13, and L14 are examples of ridge lines extracted by the extracting unit 141, that is, 3D feature lines.

The extracting unit 141 extracts edge lines from a plurality of edge lines included in a captured image, which includes an image of a structure, such that both of an angle and a distance mutually formed by the extracted edge lines are larger than threshold values and in decreasing order of the lengths. The extracting unit 141 extracts ridge lines from a plurality of ridge lines included in a three-dimensional model of the structure such that both of an angle and a distance mutually formed by the extracted ridge lines are larger than threshold values and in decreasing order of the lengths.

As the length of a feature line increases, the precision of attitude estimation increases. As the number of feature lines that have different slopes and are located apart from each other increases, the precision of attitude estimation increases. For that, the extracting unit 141 extracts feature lines in the manner described above. For example, comparing a first case where there are long feature lines that have similar slopes and are located close to each other and a second case where there are short feature lines that have different slopes and are located apart from each other, the precision of attitude estimation may be higher in the second case.

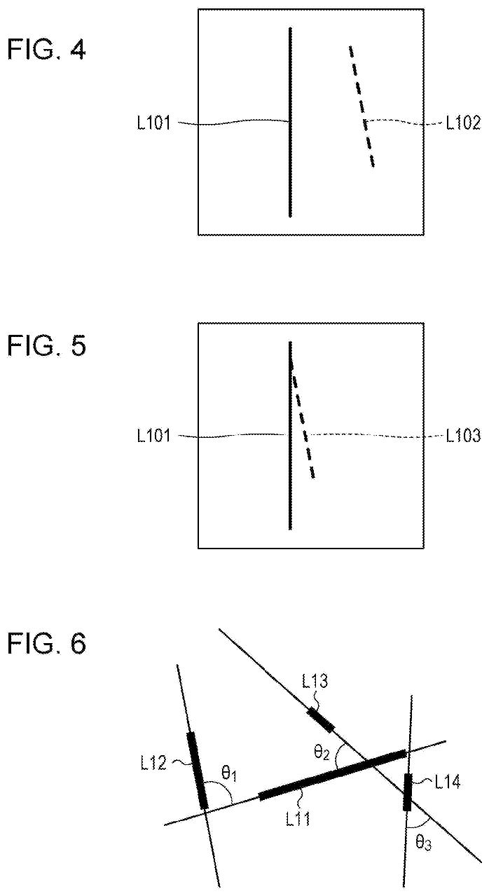

With reference to FIG. 4 and FIG. 5, the extraction of feature lines by the extracting unit 141 will be described. FIG. 4 is a diagram illustrating an example of a feature line to be extracted. FIG. 5 is a diagram illustrating an example of a feature line not to be extracted. First, the extracting unit 141 selects the longest one of unselected feature lines. The extracting unit 141 compares angles and distances formed by the selected feature line and feature lines that have already been extracted.

When none of the extracted feature lines form angles or distances equal to or smaller than preset threshold values with respect to the selected feature line, the extracting unit 141 extracts the selected feature line and handles it as an extracted feature line. The extracting unit 141 extracts 20 2D feature lines and 20 3D feature lines, for example.

The feature line L101 in FIG. 4 is an extracted feature line. The feature line L102 in FIG. 4 is a selected feature line. It is assumed that the angle formed by the feature line L101 and the feature line L102 is not equal to or smaller than a threshold value for angle. It is assumed that the distance between the feature line L101 and the feature line L102 is not equal to or smaller than a threshold value for distance. Therefore, the extracting unit 141 extracts the feature line L102.

The feature line L101 in FIG. 5 is an extracted feature line. The feature line L103 in FIG. 5 is a selected feature line. It is assumed that the angle formed by the feature line L101 and the feature line L103 is equal to or smaller than the threshold value for angle. It is assumed that the distance between the feature line L101 and the feature line L103 is equal to or smaller than the threshold value for distance. Therefore, the extracting unit 141 does not extract the feature line L103.

The selecting unit 142 selects a predetermined number of edge lines from a plurality of edge lines extracted from a captured image including an image of a structure. The selecting unit 142 selects a predetermined number of ridge lines from a plurality of ridge lines included in a three-dimensional model of the structure. The selecting unit 142 selects four edge lines and four ridge lines, for example.

The selecting unit 142 selects a predetermined number of edge lines from a plurality of edge lines extracted from edge lines included in a captured image including an image of a structure such that both of an angle and a distance mutually formed by the selected edge lines are larger than threshold values and in decreasing order of the lengths. The selecting unit 142 selects a predetermined number of ridge lines extracted from a plurality of ridge lines included in a three-dimensional model of the structure such that both of an angle and a distance mutually formed by the selected ridge lines are larger than threshold values and in decreasing order of the lengths.

The selecting unit 142 first selects a predetermined number of 3D feature lines and then selects 20 feature lines based on a formed-angle constraint. FIG. 6 is a diagram for explaining angles formed by feature lines. All of the feature lines L11, L12, L13 and L14 are 3D feature lines. It is assumed that the angle formed by the feature line L11 and the feature line L12 is θ₁. It is assumed that the angle formed by the feature line L11 and the feature line L13 is θ₂. It is assumed that the angle formed by the feature line L13 and the feature line L14 is θ₃. The feature lines in FIG. 6 correspond to the feature lines in FIG. 3 having the same references.

It is assumed that the formed-angle constraint is defined as “feature lines are selected if each of the absolute values of differences between angles formed by the feature lines is equal to or smaller than 30°”, for example. It is assumed that the angles (θ₁,θ₂,θ₃) formed by the selected 3D feature lines are (85°,75°,65°. In this case, when the angles (θ₁′,θ₂′,θ₃) formed by candidates for four 2D feature lines are (83°,76°,67°), the selecting unit 142 selects the four 2D feature lines based on the formed-angle constraint. On the other hand, when the angles (θ₁′,θ₂′,θ₃′) formed by candidates for the four 20 feature lines are (21°,18°,67°), the selecting unit 142 does not select the four 2D feature lines based on the formed-angle constraint.

The determining unit 143 determines whether the arrangement relationship of the predetermined number of selected feature lines meets a criterion for arrangement or not. When the arrangement relationship meets the criterion for arrangement, the determining unit 143 determines whether the correspondence relationship meets a criterion for correspondence or not. The determining unit 143 may determine whether the arrangement relationship meets the criterion for arrangement based on the number of mutually parallel feature lines. The determining unit 143 may determine whether the correspondence relationship meets the criterion for correspondence based on the identity of distribution conditions of feature lines.

First, processing for determining whether the arrangement relationship meets a criterion for arrangement by the determining unit 143 will be described. When the number of mutually parallel feature lines of a predetermined number of feature lines selected by the selecting unit 142 is less than a threshold value, the determining unit 143 determines that the arrangement relationship meets the criterion for arrangement. For example, when the number of mutually parallel feature lines is less than three out of four, the determining unit 143 determines that the arrangement relationship meets the criterion for arrangement. Mutually parallel feature lines may not contribute to the increase of the precision of attitude estimation but also may produce a smaller error with a wrong attitude.

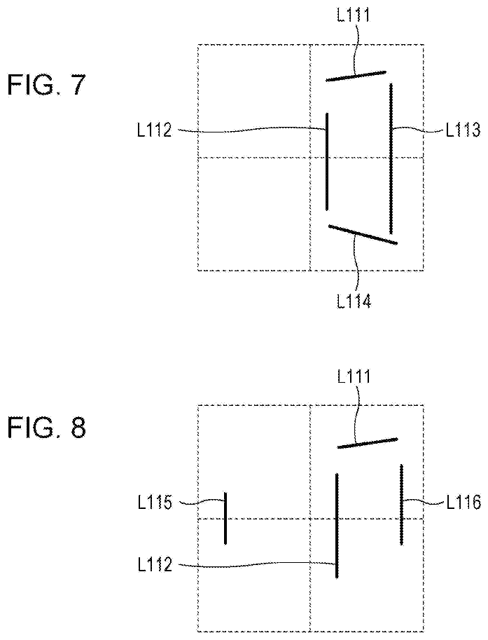

FIG. 7 is a diagram illustrating an example of feature lines when the arrangement relationship meets a criterion for arrangement. In the example in FIG. 7, because two feature lines L112 and L113 out of four feature lines L111, L112, L113, and L114 are parallel, the determining unit 143 determines the arrangement relationship meets the criterion for arrangement.

FIG. 8 is a diagram illustrating an example of feature lines when the arrangement relationship does not meet the criterion for arrangement. In the example in FIG. 8, because three feature lines L112, L115, and L116 out of four feature lines L111, L112, L115, and L116 are parallel, the determining unit 143 determines the arrangement relationship does not meet the criterion for arrangement.

Next, processing for determining whether the correspondence relationship meets a criterion for correspondence by the determining unit 143 will be described. The determining unit 143 determines whether the correspondence relationship between a distribution condition of a predetermined number of edge lines in an image region of an image of a structure in a captured image and a distribution condition of a predetermined number of ridge lines in a projection image region of a first projection image of a three-dimensional model meets the criterion for correspondence or not. This processing is performed because a large difference between the distribution conditions of the feature lines does not increase the precision of attitude estimation.

When both of the image region and the projection image region are rectangles, the determining unit 143 first divides each of the rectangles into four with straight lines connecting middle points of parallel sides of the rectangle. The determining unit 143 then determines, for each of the image region and the projection image region, whether each of the four divided regions has a middle point of a feature line. When the positional relationships of the divided regions having middle points agree between the image region and the projection image region, the determining unit 143 determines that the correspondence relationship meets the criterion for correspondence.

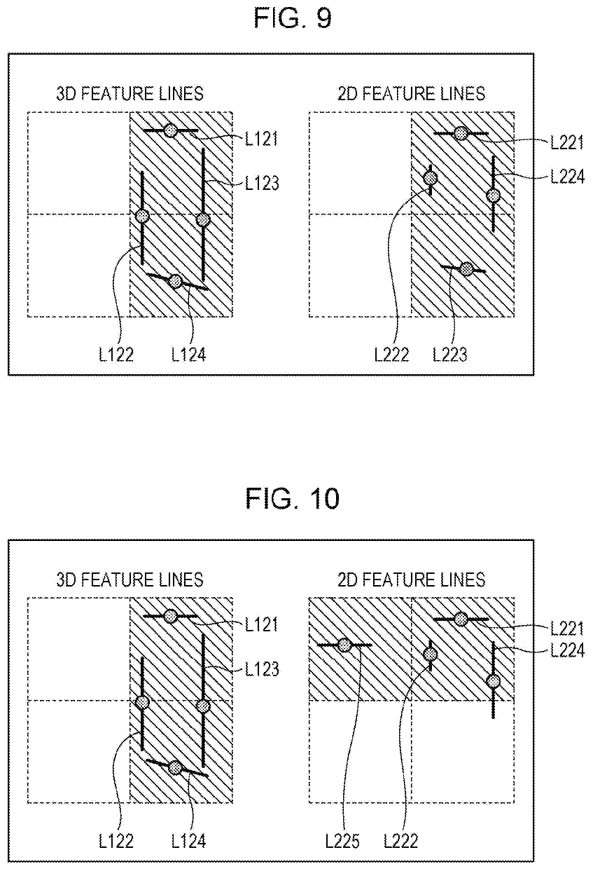

FIG. 9 is a diagram illustrating an example of feature lines when the correspondence relationship meets a criterion for correspondence. FIG. 10 is a diagram illustrating an example of feature lines when the correspondence relationship does not meet the criterion for correspondence. The upper left, upper right, lower left, and lower right divided regions in FIGS. 9 and 10 will be called a first divided region, a second divided region, a third divided region, and a fourth divided region, respectively.

In the example in FIG. 9, the middle points of 3D feature lines L121, L122, L123, and L124 are distributed in the second divided region and the fourth divided region. The middle points of 2D feature lines L221, L222, L223, and L224 are distributed in the second divided region and the fourth divided region. In this case, because the divided regions having middle points of the 3D feature lines agree with the divided regions having middle points of the 2D feature lines, the determining unit 143 determines that the correspondence relationship meets the criterion for correspondence.

In the example in FIG. 10, the middle points of the 3D feature lines L121, L122, L123, and L124 are distributed in the second divided region and the fourth divided region. On the other hand, the middle points of the 2D feature lines L221, L222, L224, and L225 are distributed in the first divided region and the second divided region. In this case, because the divided regions having middle points of the 3D feature lines do not agree with the divided regions having middle points of the 2D feature lines, the determining unit 143 determines that the correspondence relationship does not meet the criterion for correspondence.

When the correspondence relationship meets the criterion for correspondence, the generating unit 144 generates a second projection image of the three-dimensional model where the positional relationship of a predetermined number of edge lines corresponds to the positional relationship of the predetermined number of ridge lines. In a case where the determining unit 143 performs the determination regarding the arrangement relationship, the generating unit 144 generates a second projection image when the arrangement relationship meets the criterion for arrangement and the correspondence relationship meets the criterion for correspondence. The display control unit 145 displays the generated second projection image over the captured image on the display unit 11.

[Flow of Processing]

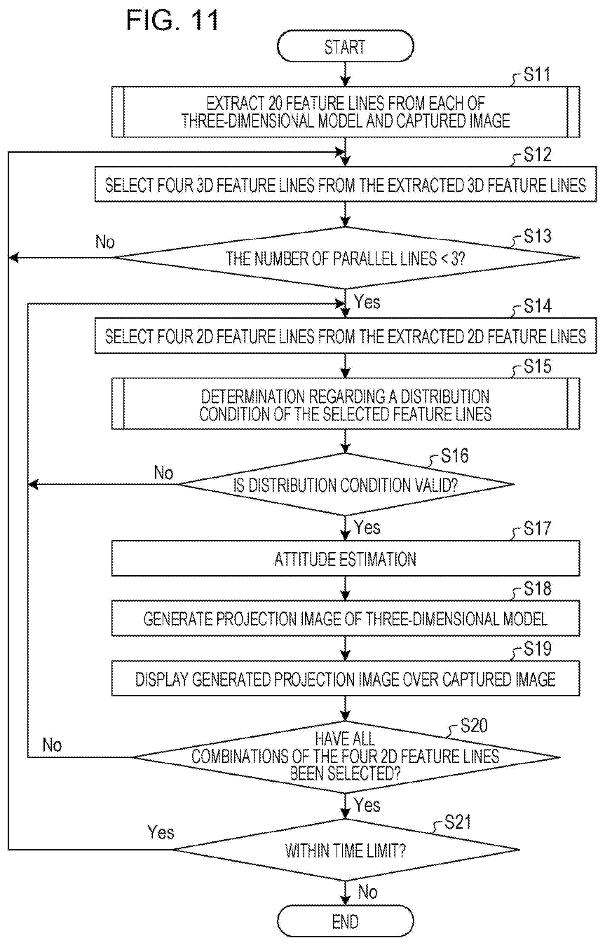

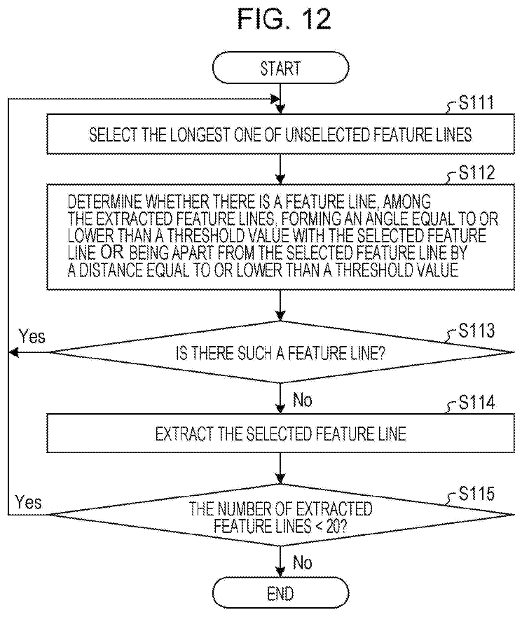

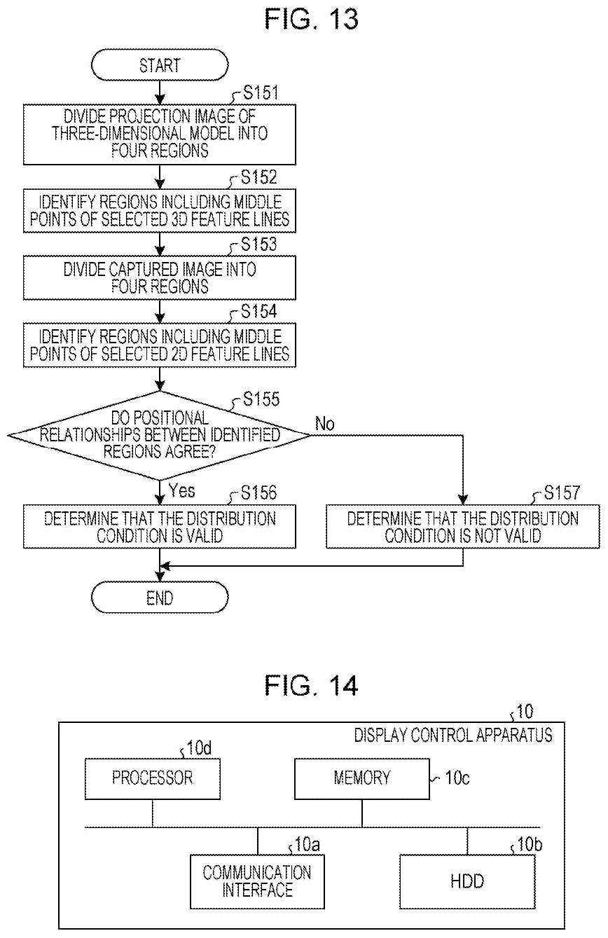

A flow of processing by the display control apparatus 10 will be described with reference to FIGS. 11, 12, and 13. FIG. 11 is a flowchart illustrating a flow of display control processing. FIG. 12 is a flowchart illustrating a flow of processing for extracting feature lines. FIG. 13 is a flowchart illustrating a flow of processing for determining a distribution condition of feature lines.

As illustrated in FIG. 11, the display control apparatus 10 first extracts, for example, 20 feature lines from each of a three-dimensional model and a captured image (step S11). In other words, the display control apparatus 10 extracts 20 3D feature lines, for example, and 20 2D feature lines, for example. The extraction processing will be described below with reference to FIG. 12.

Next, the display control apparatus 10 selects, for example, four 3D feature lines from the extracted 3D feature lines (step S12). The display control apparatus 10 determines whether the number of parallel lines among the selected 3D feature lines is less than, for example, three (step S13).

When the display control apparatus 10 determines that the number of parallel lines is equal to or more than three (No in step S13), the display control apparatus 10 returns to step S12 where new 3D feature lines are selected. On the other hand, when the display control apparatus 10 determines that the number of parallel lines is less than three (Yes in step S13), the display control apparatus 10 selects, for example, four 2D feature lines from the extracted 2D feature lines (step S14). In this case, the display control apparatus 10 selects 2D feature lines based on the formed-angle constraint.

The display control apparatus 10 performs determination regarding a distribution condition of the selected feature lines (step S15). In other words, for example, the display control apparatus 10 determines whether the correspondence relationship meets a criterion for correspondence or not. The distribution condition determination processing will be described below with reference to FIG. 13.

When the distribution condition is not valid (No in step S16), the display control apparatus 10 returns to step S14 where the display control apparatus 10 selects new 2D feature lines. On the other hand, when the distribution condition is valid (Yes in step S16), the display control apparatus 10 performs attitude estimation (step S17).

The display control apparatus 10 generates a projection image of the three-dimensional model (step S18) and displays the generated projection image over the captured image (step S19). The display control apparatus 10 determines whether all combinations of the four 2D feature lines have been selected or not (step S20).

When the display control apparatus 10 determines that some combinations have not been selected (No in step S20), the display control apparatus 10 returns to step S14 where new 2D feature lines are selected. On the other hand, when the display control apparatus 10 determines that all combinations have been selected (Yes in step S20), the display control apparatus 10 determines whether an elapsed time from the start of the processing is within a time limit or not (step S21). When the display control apparatus 10 determines that the elapsed time is within the time limit (Yes in step S21), the display control apparatus 10 returns to step S12 where new 3D feature lines are selected. On the other hand, when the display control apparatus 10 determines that the elapsed time is not within the time limit (No in step S21), the display control apparatus 10 ends the processing.

The extraction processing will be described with reference to FIG. 12. As illustrated in FIG. 12, the display control apparatus 10 first selects the longest one of unselected feature lines (step S111). Next, the display control apparatus 10 determines whether there is a feature line, among the extracted feature lines, forming an angle equal to or smaller than a threshold value for angle with the selected feature line and being apart from the selected feature line by a distance equal to or smaller than a threshold value for distance or not (step S112). When the display control apparatus 10 determines that there is such a feature line (Yes in step S113), the display control apparatus 10 returns to step S111 where a new feature line is selected. When the display control apparatus 10 determines that there is not such a feature line (No in step S113), the display control apparatus 10 extracts the selected feature line (step S114).

The display control apparatus 10 determines whether the number of extracted feature lines is less than, for example, 20 or not (step S115). When the number of extracted feature lines is less than, for example, 20, the display control apparatus 10 returns to step S111 where a feature line is further selected. On the other hand, when the number of extracted feature lines is not less than, for example, 20, the display control apparatus 10 ends the extraction processing.

The distribution condition determination processing will be described with reference to FIG. 13. As illustrated in FIG. 13, the display control apparatus 10 first divides the projection image of the three-dimensional model into, for example, four regions (step S151). The display control apparatus 10 identifies regions including middle points of the selected 3D feature lines (step S152).

The display control apparatus 10 divides the captured image into, for example, four regions (step S153). The display control apparatus 10 identifies regions including middle points of the selected 2D feature lines (step S154).

The display control apparatus 10 determines whether the positional relationships between the identified regions agree or not (step S155). When the positional relationships of the identified regions agree (Yes in step S155), the display control apparatus 10 determines that the distribution condition is valid (step S156). When the positional relationship of the identified regions do not agree (No in step S155), the display control apparatus 10 determines that the distribution condition is not valid (step S157).

[Effects]

As described above, the display control apparatus 10 selects a predetermined number of edge lines from a plurality of edge lines extracted from a captured image including an image of a structure. The display control apparatus 10 selects a predetermined number of ridge lines from a plurality of ridge lines included in a three-dimensional model of the structure. The display control apparatus 10 determines whether the correspondence relationship between a distribution condition of a predetermined number of edge lines in an image region of an image of a structure in a captured image and a distribution condition of a predetermined number of ridge lines in a projection image region of a first projection image of a three-dimensional model meets a criterion for correspondence or not. When the correspondence relationship meets the criterion for correspondence, the display control apparatus 10 generates a second projection image of the three-dimensional model where the positional relationship of a predetermined number of edge lines corresponds to the positional relationship of the predetermined number of ridge lines. The display control apparatus 10 displays the generated second projection image over the captured image on the display unit 11. In this manner, the display control apparatus 10 determines whether the criteria are met and, when the criteria are met, the display control apparatus 10 actually generates a projection image from the three-dimensional model. Thus, according to the embodiment, the amount of computational effort required for identification of a display attitude of a three-dimensional model of a structure may be reduced.

The display control apparatus 10 further determines whether the arrangement relationship of the predetermined number of selected segments meets a criterion for arrangement or not. When the arrangement relationship meets the criterion for arrangement, the display control apparatus 10 determines whether the correspondence relationship meets a criterion for correspondence or not. In this manner, when the criterion for arrangement is met, the display control apparatus 10 performs the determination on the correspondence relationship. Thus, according to the embodiment, unnecessary calculations may be omitted, reducing the amount of computational effort.

When the number of mutually parallel segments of a predetermined number of segments selected by the selecting unit 142 is less than a threshold value, the display control apparatus 10 determines that the arrangement relationship meets the criterion for arrangement. In this way, the display control apparatus 10 determines that the criterion for arrangement is not met when it is predictable that performing highly precise attitude estimation is not possible. Thus, according to the embodiment, unnecessary calculations may be omitted, reducing the amount of computational effort.

The display control apparatus 10 selects a predetermined number of edge lines from a plurality of edge lines extracted from edge lines included in a captured image including an image of a structure such that both of an angle and a distance mutually formed by the selected edge lines are larger than threshold values and in decreasing order of the lengths. The display control apparatus 10 selects a predetermined number of ridge lines extracted from a plurality of ridge lines included in a three-dimensional model of the structure such that both of an angle and a distance mutually formed by the selected ridge lines are larger than threshold values and in decreasing order of the lengths. In this way, the display control apparatus 10 selects feature lines that contribute to highly precise attitude estimation and excludes feature lines that do not contribute to an increase of precision of the attitude estimation. Thus, according to the embodiment, the amount of computational effort may be reduced by keeping the precision of the attitude estimation.

[Experiment Results]

A first experiment was performed for comparing speeds of the attitude estimation processing between a case where the processing for determining a distribution condition (the computing processing of the embodiment) was performed by the determining unit 143 and a case where the determining processing was not performed (existing computing processing). A result of the first experiment will be described. In the first experiment, 15 2D feature lines and 20 3D feature lines were extracted, and the time limit was 180 seconds.

In the first experiment, the display control apparatus 10 did not perform the processing for determining whether the criterion for arrangement is met, that is, the processing for determination regarding parallelism. In other words, for example, in the first experiment, the display control apparatus 10 repeatedly executed in 180 seconds the loop from step S12 to step S21 in FIG. 11 excluding step S13.

In the computing processing according to the embodiment, steps S15 and S16 in FIG. 11 were executed. On the other hand, in the existing computing processing, steps S15 and S16 in FIG. 11 were not executed. The number of loops was equal to the number of times of execution of step S12. As a result, while the number of loops was equal to about 40 in the existing computing processing, the number of loops in the computing processing according to the embodiment was equal to about 60 to 250. In other words, for example, while only 40 attitudes of a three-dimensional model might be evaluated within the time limit in the existing computing processing, about 60 to 250 attitudes might be evaluated within the time limit in the computing processing according to the embodiment.

A second experiment was performed for comparing speeds of attitude estimation processing between a case where the processing for performing the determination regarding the arrangement relationship (computing processing with the parallelism determination) was performed by the determining unit 143 and a case where the determination processing was not performed (computing processing without the parallelism determination). A result of the second experiment will be described. In the second experiment, 15 2D feature lines and 20 3D feature lines were extracted, and the time limit was 180 seconds, like the first experiment. In the second experiment, the display control apparatus 10 repeatedly executed in 180 seconds the loop from step S12 to step S21 in FIG. 11 excluding step S13.

In the computing processing with the parallelism determination, step S13 in FIG. 11 was executed. On the other hand, in the computing processing without the parallelism determination, step S13 in FIG. 11 was not executed. The number of loops was equal to the number of times of execution of step S12. As a result, while the number of loops was equal to about 1000 to 1100 in the computing processing without the parallelism determination, the number of loops in the computing processing with the parallelism determination was equal to about 1200 or more. Therefore, it may be said that performing the arrangement relationship determination processing increases the computing speed about 1.1 times.

According to the embodiment, the determining unit 143 divides a projection image and a captured image into four regions to perform the distribution condition determination processing. However, the determining unit 143 may perform the distribution condition determination processing in other manners. For example, when a total of distances between middle points of feature lines is equal to or smaller than a threshold value, the determining unit 143 may determine that the correspondence relationship between distribution conditions meets a criterion for correspondence.

The method for extracting feature lines by the extracting unit 141 is not limited to the method described above. For example, the extracting unit 141 may extract feature lines randomly or may extract feature lines manually designated in advance.

[System]

Processing procedures, control procedures, specific names, and information containing various kinds of data and parameters indicated in the specification and the drawings may be changed in any manner unless otherwise specified. The specific examples, distributions, numerical values, and so on described in the embodiment are merely examples and may be changed in a given manner.

The constituent elements of the apparatuses illustrated in the drawings are functionally conceptual ones and do not necessarily have to be physically configured as illustrated. Specific forms of distribution and integration of the devices are not limited to those illustrated in the drawings. In other words, for example, all or some of the apparatuses may be configured to be distributed or integrated functionally or physically in given units depending on, various loads, usage conditions, and so on. All or given some of processing functions performed by the apparatuses may be implemented by a central processing unit (CPU) and a program to be analyzed and executed by the CPU, or may be implemented as hardware by wired logic.

[Hardware]

FIG. 14 is a diagram illustrating an example of a hardware configuration. As illustrated in FIG. 14, the display control apparatus 10 includes a communication interface 10a, a hard disk drive (HOD) 10b, a memory 10c, and a processor 10d. The components illustrated in FIG. 14 are coupled to each other by, for example, a bus.

The communication interface 10a is a network interface card or the like and performs communication with other servers. The HOD 10b stores a program and databases (DB) for causing the functional units illustrated in FIG. 1 to operate.

The processor 10d executes processes that implement the functions illustrated in, for example, FIG. 1 by reading from the HOD 10b or the like the program that implements processing operations identical to those of the processing units illustrated in FIG. 1 and loading the program into the memory 10c. In other words, for example, this process performs a function that is substantially the same as that of each of the processing units included in the display control apparatus 10. More specifically, for example, the processor 10d reads a program having substantially the same functions as the extracting unit 141, the selecting unit 142, the determining unit 143, the generating unit 144 and the display control unit 145 from the HOD 10b or the like. The processor 10d performs, by executing the program, a process of performing processing that is substantially the same as the processing of the extracting unit 141, the selecting unit 142, the determining unit 143, the generating unit 144, the display control unit 145, and so on. The processor 10d is, for example, a hardware circuit such as a central processing unit (CPU), a microprocessor unit (MPU), and an application specific integrated circuit (ASIC).

As described above, the display control apparatus 10 operates as an information processing apparatus that carries out a display control method by reading and executing a program. The display control apparatus 10 may implement functions that are substantially the same as those of the embodiments described above by reading the program from a recording medium with a medium reading apparatus and by executing the read program. The program is not limited to a program executed by the display control apparatus 10. For example, the present disclosure may also be applied to cases where another computer or a server executes the program and where another computer and a server execute the program in cooperation with each other.

The program may be distributed via a network such as the Internet. The program may be recorded on a computer-readable storage medium such as a hard disk, a flexible disk (FD), a compact disc read-only memory (CD-ROM), a magneto-optical disk (MO), or a digital versatile disc (DVD) and may be executed after being read from the storage medium by a computer.

According to one aspect, the amount of computational effort required for identification of a display attitude of a three-dimensional model of a structure may be reduced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A display control method, comprising:
selecting, by a computer, a predetermined number of edge lines from a plurality of edge lines extracted from a captured image including an image of a structure;
selecting the predetermined number of ridge lines from a plurality of ridge lines included in a three-dimensional model of the structure;
determining whether a correspondence relationship between a distribution condition of the predetermined number of edge lines in an image region of the image of the structure and a distribution condition of the predetermined number of ridge lines in a projection image region of a first projection image of the three-dimensional model meets a first criterion;
generating, when the correspondence relationship meets the first criterion, a second projection image of the three-dimensional model where a positional relationship of the predetermined number of edge lines corresponds to a positional relationship of the predetermined number of ridge lines; and
displaying the generated second projection image over the captured image on a display unit.

2. The display control method according to claim 1, further comprising:
determining whether an arrangement relationship of segments meets a second criterion, the segments being the predetermined number of edge lines or the predetermined number of ridge lines; and
determining, when the arrangement relationship meets the second criterion, whether the correspondence relationship meets the first criterion.

3. The display control method according to claim 2, wherein
the second criterion is that a number of mutually parallel segments out of the segments is less than a predetermined threshold value.

4. The display control method according to claim 1, further comprising:
selecting the predetermined number of edge lines in decreasing order of lengths of the plurality of edge lines such that both of angles and distances mutually formed by the selected edge lines are larger than predetermined threshold values; and
selecting the predetermined number of ridge lines in decreasing order of lengths of the plurality of ridge lines such that both of angles and distances mutually formed by the selected ridge lines are larger than the predetermined threshold values.

5. A display control apparatus, comprising:
a memory; and
a processor coupled to the memory and the processor configured to:
select a predetermined number of edge lines from a plurality of edge lines extracted from a captured image including an image of a structure;
select the predetermined number of ridge lines from a plurality of ridge lines included in a three-dimensional model of the structure;
determine whether a correspondence relationship between a distribution condition of the predetermined number of edge lines in an image region of the image of the structure and a distribution condition of the predetermined number of ridge lines in a projection image region of a first projection image of the three-dimensional model meets a first criterion;
generate, when the correspondence relationship meets the first criterion, a second projection image of the three-dimensional model where a positional relationship of the predetermined number of edge lines corresponds to a positional relationship of the predetermined number of ridge lines; and
display the generated second projection image over the captured image on a display unit.

6. A non-transitory computer-readable recording medium having stored therein a program that causes a computer to execute a process, the process comprising:
selecting a predetermined number of edge lines from a plurality of edge lines extracted from a captured image including an image of a structure;
selecting the predetermined number of ridge lines from a plurality of ridge lines included in a three-dimensional model of the structure;
determining whether a correspondence relationship between a distribution condition of the predetermined number of edge lines in an image region of the image of the structure and a distribution condition of the predetermined number of ridge lines in a projection image region of a first projection image of the three-dimensional model meets a first criterion;
generating, when the correspondence relationship meets the first criterion, a second projection image of the three-dimensional model where a positional relationship of the predetermined number of edge lines corresponds to a positional relationship of the predetermined number of ridge lines; and
displaying the generated second projection image over the captured image on a display unit.
